(19) United States
(12) Patent Application Publication
(10) Pub. No.: US 2017/0053318 A1
(43) Pub. Date: Feb. 23, 2017

(54) METHOD, SYSTEM, APPARATUS AND PROGRAM FOR SERVING TARGETED ADVERTISEMENTS AND DELIVERING QUALIFIED CUSTOMER RECORDS BY USING REAL-TIME DEMOGRAPHIC, META AND DECLARED DATA

(71) Applicant: FLUENT, LLC, New York, NY (US)

(72) Inventors: Sean CULLEN, New York, NY (US); Yan Xing Huang, New York, NY (US); Man Kit Kwan, New York, NY (US); Ngaibun Yeung, New York, NY (US)

(73) Assignee: FLUENT, LLC, New York, NY (US)

(21) Appl. No.: 14/832,796

(22) Filed: Aug. 21, 2015

(51) Int. Cl. G06Q 30/02

(52) U.S. Cl. CPC G06Q 30/0269

(57) ABSTRACT

A system and method for using user declared combined with demographic and meta data to create a detailed user profile that reflects current purchase intentions. This enables serving in real-time targeted advertisements to a user at a user terminal including a desktop PC, tablet or internet connected mobile device. Because the user profile is immediately available in real-time to the website operator and its ad server, the system and method provide for instantaneous and accurate targeting of web advertising to users which has a higher response rate than advertisements selected and delivered relying on just demographic data and/or online behavior which may be obtained from tracking cookies set on the user's computer or other connected device. The system and method also use the real-time generated user profile to facilitate the delivery of customer records after multiple steps of system operator adjusted filtering that optimizes customer record performance based on the needs and specifications dictated by the client and/or the particular product or service being offered. Customer records are delivered in real-time via an online data transfer to the client or via batch file transfer to the client.

### BACKGROUND OF THE INVENTION

Field of the Invention

The present invention generally relates to a method, system, apparatus, and program for serving targeted advertisements and delivering qualified customer records, and more particularly to an improved method, system, apparatus, and program for serving targeted advertisements and delivering qualified customer records by using real-time declared data combined with demographic data and meta data. Qualified customer records are, for example, records relating to customers who are considered to have real potential to be interested in a particular product or service that is advertised based on the user profile which is created by combining demographic data, meta data, and declared data. (It is noted that as used herein the term “qualified customer record” is interchangeable with the term “customer record.”) In general and as used herein to describe the present invention, demographic data refers to self-reported user information such as name, address, gender, email address, telephone number and date of birth. Meta data includes information gleaned by the system such as the user's IP address, browser type, operating system, and, for mobile connected devices, the device model, device ID, browser, and mobile carrier, and may be supplemented with third party data sources. Declared data are user responses to dynamically curated and served survey questions.

Related Art

Advertising has always been an imprecise exercise in attempting to get a relevant advertisement in front of an interested customer. As famously noted by John Wanamaker, founder of the first department store in Philadelphia, “Half the money I spend on advertising is wasted; the trouble is, I don't know which half.”

With the advent of the Internet, email, and online advertising, advertisers sought to harness the power of the Internet and tracking capabilities of computers to add precision to serving ads to customers. In the early days of the Internet, online advertising was mainly comprised of banner ads. Websites were paid based on impressions (i.e., the number of users on a page where the ad was displayed) which was referred to as “cost per thousand views” (technically, “cost per mile” or CPM). Advertisers selected the websites on which to display their ads by several methods, all of which were imprecise and led to poor click through rates. In response to this, methods were developed whereby advertisers paid for ads based on the number of clicks on an ad or a cost per click (CPC) basis. This enabled advertisers to tailor their advertisements and placements based on click through rates to enhance the performance of the ads. However, one drawback was that ad placements were still largely on a hit or miss basis.

Cookies, which are small text files on a user's computer that track users' online activities, were tapped by ad servers to try to serve relevant ads based on a user's past browsing behavior. The idea was that past browsing behavior would indicate interest and future purchase intention. Data derived from cookies is referred to as inferred data. This improved performance, but, the Applicants note, was backward looking as past browsing may not be indicative of current interests. For example, a user searching for a patio set will be displayed relevant ads when the user browses the Internet. These ads will continue to be served for some time period well after the customer has completed his or her purchase as the information of current buying intent becomes stale.

As the number of websites exploded, search engines were needed to comb through the mass of new websites. This led to the development of a bidding system so that advertisers could bid for search terms. Google modified this to enable ads with higher click through rates to appear higher in the rankings to add relevance to the rankings. Google charged advertisers on a pay per click basis for user clicks on displayed search results and also enable advertisers to have paid listings on search result pages.

While more refined than just serving up banner ads blindly based on few criteria, the Applicants note that this methodology too was flawed in that a Google search may have nothing to do with a potential buying decision. For example, searching for “Apollo 13” might mean that the user is interested in learning about the flawed mission or they want to buy the movie. Without more data on the particular user such as whether the user frequently bought movies, a significant portion of the clicks on the Apollo 13 search results could be expected to not result in a purchase decision, bringing advertisers full circle to the earlier-noted Wannamaker's maxim.

There exists, therefore, a need to provide a novel method, system, apparatus, and program that overcomes the above-noted and other drawbacks of the existing methods.

### SUMMARY OF THE INVENTION

The present invention in one embodiment uses declared data from users via curated survey questions integrated with demographic date and meta data to ascertain users' current declared intent. The system of the present invention then uses this data to direct responsive ads from an array of available advertisements on the system's ad server to the customers who are identified by the system to more likely be interested in the particular ads.

In more detail, “declared data” as used herein refers to user data that is explicitly specified or declared by a user himself or herself, such as by responses to the curated survey questions of the present invention. In contrast, “inferred data” refers to user data that is derived or inferred based on, for example, past browsing history which may be stored in cookies—small files stored on the user's device that track online browsing history. Unlike typical ad serving/customer record generation techniques currently in use, the present invention does not rely on inferred data because of the principal limitation of inferred data in that it is backward looking rather than necessarily reflecting current intent.

The system of the present invention has application to direct marketing. To date, most direct marketing uses demographic or lifestyle data available from third party data enhancement services, such as household income, to determine a prospect's ability to pay. However, such data provides little information in regard to willingness or readiness to purchase. In response to this, the present invention in one embodiment uses, for example, curated survey questions to elicit declared intent, thereby enabling the development of a more accurate user profile that ascertains current buying intentions. The present invention also uses demographic and other data to filter out potential prospects that are unlikely buyers. The present invention thereby enables the delivery of interested identified customers in real-time or in near real-time to advertisers/direct marketers, thereby providing them with actionable “hot” prospects. The advertisers/direct marketers can then use a variety of contact methods such as telephone, and email or the system of the present invention can direct users to the advertiser's site to directly market to these customers, thereby advancing the state of the art for direct marketing.

The present invention uses feedback from advertisers of the actual performance of the qualified customer records submitted (e.g., information as to whether a customer made a purchase) to refine the curation of survey questions, and uses demographic and meta data and other filters to refine the selection criteria in order to better predict behavior and improve performance and utility of the customer records. In one embodiment of the present invention this portion utilizes manual intervention. The feedback data submitted by advertisers is analyzed to derive the most valuable customers (MVCs), namely, customers that responded to the offer in the desired manner. The data points of the MVC's are then analyzed to determine the common characteristics such as traffic source (email, banner ads, and search terms), product or promotional offer type, age, geographic location, declared data responses, etc. The common characteristics are identified and used to adjust the parameters used by the present invention to refine the selection process of qualified customer records to improve the performance thereof, to thereby increase the percentage of qualified customer records that will take the desired action be it signing up for a newsletter, installing an app on their mobile device, or buying a particular product or service offered by an advertiser. The aforementioned analysis can in another embodiment of the present invention be performed automatically by a computer system executing a program that analyzes the feedback data submitted by advertisers to derive MCVs and identify common characteristics of the MCVs which are used to adjust the parameters used to refine the selection process of qualified customer records. For example, if 1,000 customer records are sent to an advertiser and the advertiser provides feedback that 300 of the MVCs purchased the particular product or service at issue, the system can analyze the 300 MVCs for commonality (e.g., in traffic source; in age; in geographical location, etc.) and then can (a) adjust or refine the survey questions based on the analysis and/or (b) weight a common feature (e.g., age range from 20-30) more heavily in providing customer records for similar products or services in the future. Thus, the present invention addresses the problem of imprecision in ad serving and customer generation (i.e., identifying to advertisers customers who have real potential to be interested in buying a particular product or service being advertised) which persists to this day in the online environment.

The present invention also addresses a new problem related to the online environment, of click fraud. Click fraud is a type of fraud that occurs on the Internet in pay per click (PPC) online advertising when a person, automated script, or computer program imitates a legitimate user of a web browser clicking on an ad, for the purpose of generating a charge per click without having actual interest in the target of the ad's link. It has been reported that as much as a third of online ad traffic may in fact be fraudulent. See, e.g., “A ‘Crisis’ in Online Ads: One-Third of Traffic Is Bogus”, Vranica, Suzanne, Mar. 23, 2014, Wall Street Journal.

The present invention addresses these two problems, ad imprecision and click fraud, by bringing numerous pieces of data together such as demographic data, meta data, and declared data derived from user responses to carefully tailored survey questions. This data results in a detailed current profile of a real user. This has the benefit of avoiding click fraud because it is extremely difficult to program a BOT to respond to a series of survey questions relating to self-reported conditions and/or preferences, and to whom ads can be served that demonstrably perform better than comparable ad serving technologies. The data collected drives not only the ad verticals served, but the order in which they're served, and the format and appearance of the creative that's displayed. Rather than relying on algorithms or other programmatic techniques, the present invention in one embodiment relies on continuous “A/B testing” of different strategies to derive the best performance from the users based on numerous data points including feedback from advertisers. Thus, “A/B testing” as used herein refers to the act of running a split testing between two or more scenarios to see which performs or converts the best; it tests a control (version A) against a different version (version B) to determine which is the most successful based on the metric being measured. For example, if we are looking for customers for auto insurance, the A/B test could involve comparing the results of asking the survey question “Do you own a car?” with the results of asking a second follow-up question such as “Are you interested in getting a cheaper quote on a car insurance?” The results from the more qualified user in the second scenario is compared with the fall off in user progression in the flow due to asking a second question. (A greater percentage of users can be expected to drop out of the flow as more survey questions are asked.)

The present invention can go a number of steps further. First, if the advertiser/client has provided data on users who have actually made a purchase or taken some other desired action in response to an ad served or a customer record provided using the present invention, the present invention enables the analysis of the data points of these users to further refine the process such as the selection and order of survey questions to be presented and the filters applied. In effect, the invention enables continuous refinement to achieve ever better performance. It also enables, through the use of complex database searches, the identification of users with similar user profiles to the users who positively responded to ads, so called “look-alike” users, for future ad targeting.

The present invention also provides a means for monetizing return users. The technique of displaying the same ad to a returning user after he or she has already seen it can be expected to not perform well on average. The invention identifies such a user and serves a different ad to the user which can enhance the monetization of that user.

Furthermore, the present invention facilitates the insertion of user profiles via cookies on a user's browser that can be accessed by an ad network to target relevant ads when a user is online and is identified by the ad network.

Moreover, the present invention can provide a cost-effective scalable method of acquiring qualified customer records to feed the top of the customer acquisition funnel. Customer acquisition has been found to be the most difficult aspect of online advertising. See, e.g., IBM, “State of Marketing 2013, IBM's Global Survey of Marketers.” This is because of cost, lack of expertise, and the confusing landscape of online advertising as evidenced by the family of Lumascape charts. Source, http://www.lumapartners.com/resource-center/lumascapes-2/. Among the improvements of the present invention over the related art is that the present invention facilitates the identification of users at scale with current buying intention.

The present invention's solution is unconventional (i.e., contrary to conventional wisdom) because the system focuses on using declared data in addition to meta data and demographic data while the current trend is towards systems that merely use inferred data. For example, a case study in an Equifax publication (http://www.equifax.com/assets/eBooks/ixi_services_digital_marketing_best_practices.pdf) entitled “A Guide to Better Digital Adverting though Data” discusses using inferred data from a targeted database to identify potential customers interested in leasing a luxury automobile. The data, which was derived from several sources, including zip code and browsing history, included the following segments:
Income greater than $250,000;
Discretionary Spending over $100,000; and
Customers In-market for an Auto Lease.

The case study concluded that when a campaign is driven through ad exchanges deploying real-time bidding technology, these types of segments can be used to trigger bids, helping to ensure that advertisers eliminate wasted spending on unqualified customers (i.e., customers who aren't likely to be interested in a particular product or service being advertised). The targeting occurs in real-time, without disturbing the user's browsing experience.

In contrast to the above, the system of the present invention in one embodiment uses declared data (e.g., user responses to curated dynamically selected survey questions) in addition to demographic data and meta data to build a more accurate targeted user profile. Among other improvements over the related art is that the collection of declared data facilitates the selection of customer records that are more accurately targeted than when merely using inferred data, to exclude unqualified customers. Thus, the present invention can better identify currently interested qualified customers, in addition to better excluding unqualified customers. For example, if a user responds in the negative to the survey question, “Do you own a car?” that will clearly exclude the user from an auto insurance ad or as a customer for auto insurance customer record purchaser.

Furthermore, the inventors of this application have noted that the current trend in digital ad serving is moving strongly towards a “programmatic” ad marketplace. In essence, “programmatic” ad serving enables buyers and sellers of ads to bid on and price ads in a real-time exchange. Buyers can consider every ad impression, determine its value, and then decide on a bid. Sellers can display unsold inventory in real-time, set a reserve price, and ultimately realize larger bids via programmatic selling. The evolving view is that programmatic ad serving provides a highly efficient, high quality ad marketplace that delivers value to both buyers and sellers. Consequently, the use of programmatic ad exchanges is growing rapidly. See, e.g., “What You Should Know about Programmatic Advertising”, Botnott, John, INC., Mar. 4, 2015.

The present invention bucks the current trend of using programmatic ad exchanges in that in one embodiment it enables manual system adjustment and the use of qualitative measures, some of which may not be measurable, to achieve better performance and/or overall desired results which may not be deemed optimal from a purely analytic perspective. For example, the system enables adjustments to the user experience by, e.g., redesigning creatives or adjusting the order of survey questions, to enhance user progression. These changes may reflect, for example, feedback from a client as to the performance of customer records, delivered by the system of the present invention that the system operator uses to refine the user experience for improving the quality of the delivered customer records. Alternatively, the adjustments can be derived from segmented A/B testing assessing the impact of qualitative changes of the user experience on the quantitative performance of generated qualified customer records. And powerfully, the advertiser feedback enabling the identification of MVCs can dramatically improve the performance of qualified customer records selected by the present invention and delivered to advertisers/customer record purchasers,

The system of the present invention also enables the creation of “exceptions,” to facilitate building longer-term business relationships. For example, the system operator may place an ad in a first position (e.g., the best performing location) even if the ad's performance or the price paid by the advertiser may not dictate that position, if the system operator is interested in fostering a longer-term relationship with the client.

By facilitating manual, non-programmatic adjustments in the operation of the system, the system operator is able to build unique programs that align and often streamline the customer acquisition model for a particular client. This can serve to tie the client to the system operator because of the system operator's ability and willingness to fine tune the system to achieve results desired by the client and which consistently exceed those available in a purely automated environment.

Ultimately, the system flexibility fueled by the client feedback loop can enable the system operator to make marketing and ad serving decisions based on a broader range of business goals.

### BRIEF DESCRIPTION OF THE DRAWINGS

The features and advantages of the present invention will be more readily understood from a detailed description of the exemplary embodiments taken in conjunction with the following figures in which:

FIG. 1 is a block diagram of prospect acquisition and derivation of prospect identity information (demographic and meta data) and declared data via survey questions, according to an embodiment of the present invention.

FIG. 2 is a block diagram of targeted real-time ad serving based on a user profile derived from declared and meta data, and placement of retargeting pixel, post fulfillment, and strategic exit monetization, according to an embodiment of the present invention.

FIG. 3 is a block diagram of qualified customer record generation based on user profile using filtering for criteria tied to needs of the client purchasing the qualified customer record or the needs specific to the particular offer and return path scoring, according to an embodiment of the present invention.

FIG. 4 is a block diagram of hardware used in an embodiment of the present invention.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

The present invention is now described in terms of an exemplary system in which the present invention, in various embodiments, would be implemented. This is for convenience only and is not intended to limit the application of the present invention. It will be apparent to one skilled in the relevant art(s) how to implement the present invention in alternative embodiments.

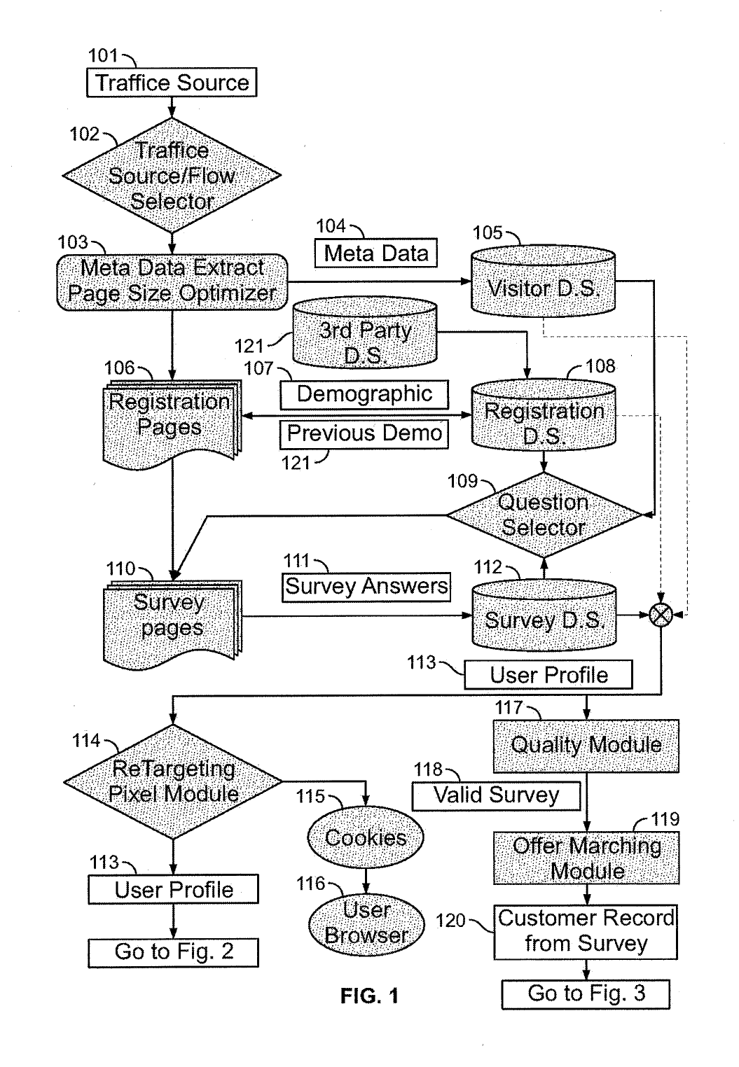

FIG. 1 is one implementation of a first stage of a system according to one embodiment which is the acquisition of prospective customers and the creation of user profiles.

A first party ad serving and qualified customer record generation system is provided. The system relies on user-declared registration information (demographic data) (107), combined with meta data (104), to dynamically populate a curated series of survey questions. The demographic data may be supplemented with third party data sources (121). For example, the system can ping a third party service provider's data base to determine the wireless carrier of the user. The users of particular wireless carriers fall into certain demographic categories that can impact performance. The user-declared responses to the survey questions (111) are collected and combined with the meta data (104) and demographic data (107) for use in determining which ads are to be served by the system's ad server (202). This data is subject to multiple filters established by the system operator and/or the customer record purchaser (advertiser) and is used to identify qualified users who meet the specified complex parameters to be submitted to customer record purchasers (e.g., advertisers who are purchasing customer records) in real-time. Qualified users are, e.g., customers who have real or significant potential to be interested in purchasing a particular product or service being advertised.

Prospective users are directed from a variety of traffic sources (101) such as email, banner ads, and search terms by a traffic source/flow selector (102) through a meta data extract page size optimizer (103) to landing/registration pages (106). The ads used by the traffic sources (101) are directed to products such as promotional offers, sweepstakes, free samples, and job listings; additional products can also be developed to attract a different demographic of users.

Initially, the system gathers two types of information: meta data (104) and demographic data (107).

The meta data extract unit (103) extracts meta data (104) using known methods and stores it in the visitor data store (105). Meta data (104) can, for example, include the user's IP address, the geographic location of the IP address using a third party service, device type, browser and browser version, operating system and version, screen size, traffic source, product, user agent, and the date/time stamp when the user first visited the site. Of course, meta data (104) is not limited to these examples.

The system determines from the user agent which is a part of the meta data extractor (103) the device type (such as desktop PC, tablet, or smartphone and the smartphone make and model) and which group of design creatives to be used to present the balance of the product flow to best display on the device being used by the user, e.g., the design creatives displayed to a mobile user will be optimized for the limited screen size of mobile devices.

The user first interacts with a registration page (106) where the system seeks to gather user-declared demographic data (107) which is stored in the registration data store (108). The user-declared demographic data (107) includes, e.g., the user's name, email, phone number, address, gender, and date of birth. The demographic data (107) may be supplemented with third party data by pinging a third party data provider (121). For example, the system may ping a third party carrier look-up service to determine the user's wireless carrier and then add this information to the registration data store (108). The system also determines whether the user is a returning user by sending the user email address to the registration data store (108) and queries the database contained therein. If the user is a returning user, the registration data store (108) sends the user's previously supplied demographic information (107) to the registration pages which is prepopulated on the registration pages (106). If the user is not a returning user then the system will elicit demographic information by displaying the registration pages. (106)

After the registration pages (106), the question selector (109) then determines which survey pages (110) to display as well as the order using, e.g., the meta data (104), demographic data, traffic source (101), and product, the information regarding whether the user is a returning user and any previous survey answers (111). The question selector will also take into account the current offers and customer record purchasers that are available in determining which survey questions to serve. For example, if there are pharma advertisers looking for customer records from users who report that they are diabetic, the question selector may serve a survey question such as “Do you have diabetes?”

Survey answers (111) to the survey pages (110) are stored in the survey data store (112) and fed back into the question selector (109) which determined whether to serve follow-up survey questions. For example, a “Yes” survey answer (111) to the question “Do you own a car?” may prompt the question selector (109) to insert a follow-up survey page (110) that asks “Do you want to lower your auto insurance premium?”

The system of the present invention combines meta data (104), and demographic data (107) with survey answers (111) to create a user profile (113). The user profile (113) is fed into the retargeting pixel module (114) which creates one or more cookies (115) which are inserted into the user browser (116) on the user's device. Accordingly, the present invention can, for example, facilitate the insertion of user profiles (113) via cookies (115) on the user's browser (116) that can be accessed by an ad network to target relevant ads when a user is online and is identified by the ad network.

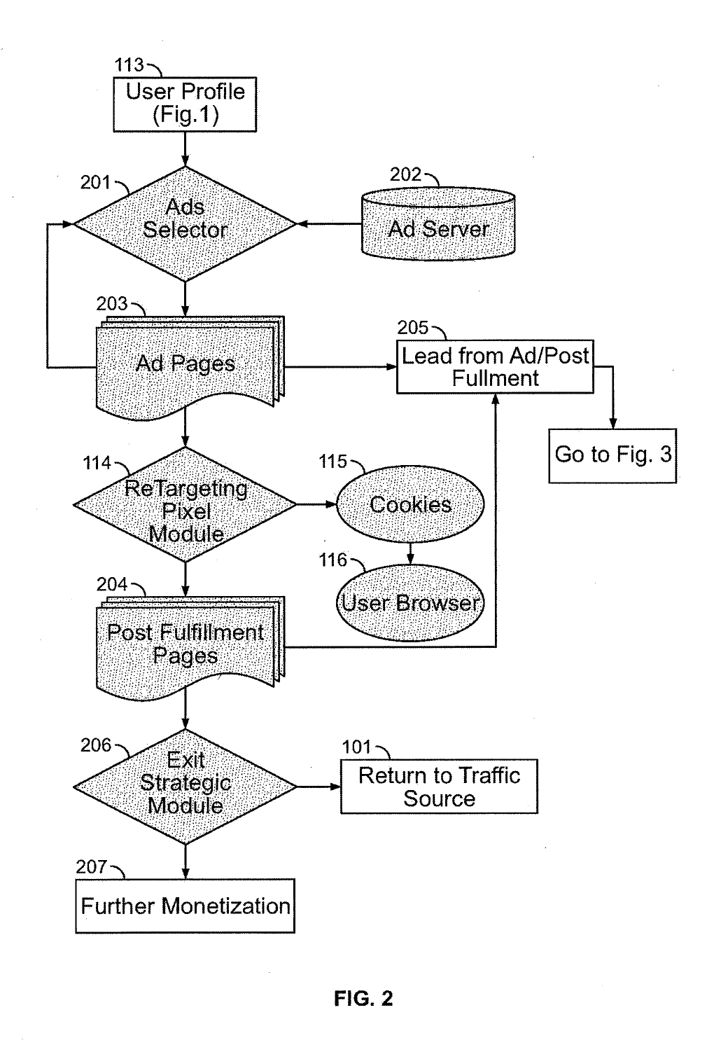

The user profile (113) is also fed into the ads selector (201) (see the top of FIG. 2) for ad serving.

For customer record generation, the user profiles (113) are subject to filtering in the quality module (117) which validates the registration data and performs a profanity check. If the user profile (113) is validated by the quality module (117), the quality module (117) outputs a valid survey (118) with the associated user profile (113). The valid survey (118) and associated user profile (113) is then fed into the offer matching module (119).

The offer matching module (119) filters and matches a valid survey (118) and associated user profile to specific advertisers and/or offers in a three step process. For these purposes, advertisers and/or offers can include offers for specific products or services in any number of advertising verticals including, for example, home energy, health and wellness products, refinancing offerings, or consumer package goods. The first step is a duplication check to ensure that the valid survey (118) and associated user profile (113) is not submitted to an offer to which it had been previously submitted. (Most advertiser clients will reject duplicate customer records and the system pre-emptively seeks to prevent re-submission of a previously submitted customer record to the same advertiser.) Second, the offer matching module (119) checks a global list of “black listed” users and offers and weeds out specific excluded users. Finally, the offer will typically have specific combinations of demographic data (107), meta data (104), and declared data—responses to specific survey questions—to narrow the class of qualified customer records thereby improving the quality thereof. Advertisers measure the quality of the qualified customer records based on, in general, how many of the users respond to the contact by the advertisers by, for example, actually signing up for the offer, signing up to receive additional information or subscribing to a sponsored newsletter.

For example, offer requirements may include the following:

“Offer A”, a refinance offer, wants 18+, Home Owner, NY resident, 50K+ Debt.

“Offer B”, an education offer, wants 18+, no degree, wants to continue education.

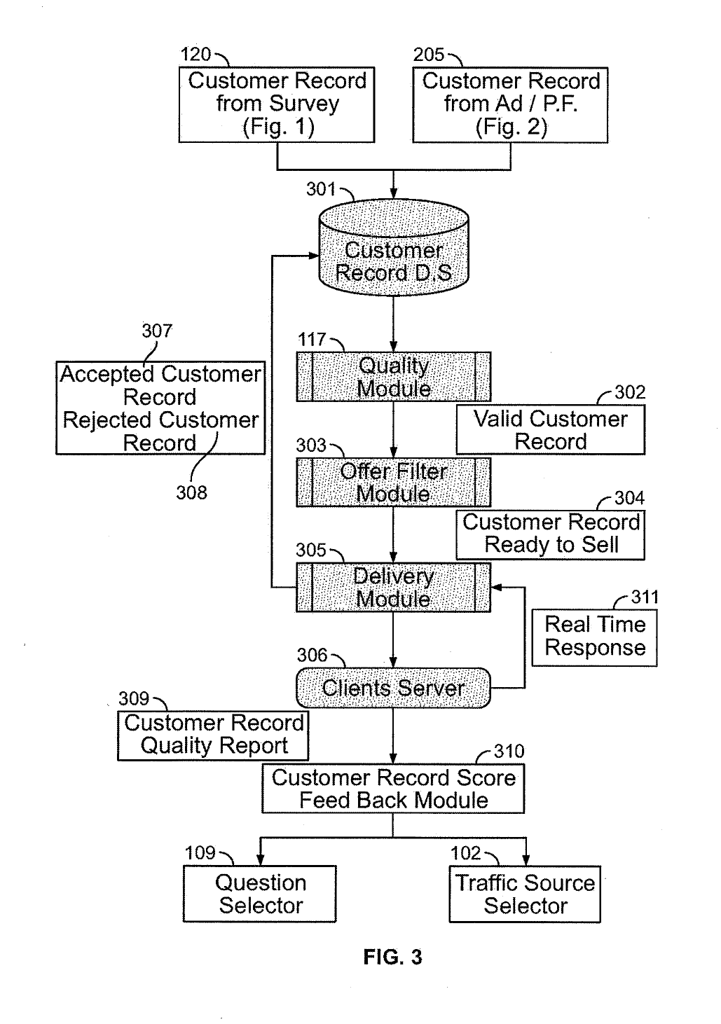

If the valid survey (118) matches, for example, the Offer A requirements and is not otherwise filtered, it is saved as a customer record from survey (120). If a valid survey (118) matches more than one offer, a separate customer record from survey (120) for each matched offer is created. FIG. 3, which is explained further below, shows the system and processes applicable to customer record generation.

FIG. 2 depicts the Ad Serving system and processes according to an embodiment of the present invention. A user profile (113) is fed into the ad selector (201). The ad selector (201) selects from an array of third party advertisements, stored on the ad server (202), and displays ad pages (203). If the user is a returning user, the user profile (113) will include data on the ad pages (203) previously served to the user so that the ad server (202) can avoid serving duplicate ad pages (203).

The user profile (113) is again fed into retargeting pixel module (114) which then places one or more cookies (115) on the user's browser (116). The cookies (115) placed on the user's browser (116) can for example, be accessed by an ad network to target relevant ads when a user is online and is identified by the ad network.

After the ad pages (203), the user is displayed post fulfillment pages (204). The user interaction with the post fulfillment pages (204) are added to the customer record from ad/post fulfillment (205) and handled, as described in FIG. 3, by the customer record data store (301).

From the post fulfillment pages (204), the user is then passed to the exit strategic module (206). The exit strategic module (206) redirects the user back to the traffic source (101) which is typically a third party website that the user was on before the user entered the flow. Alternatively, the exit strategic module (206) may redirect the user to other advertisements, which may include remnant ad inventory, in the further monetization module (207).

FIG. 3 shows the systems and processes applicable to customer record generation. In general, customer record generation entails the delivery of a qualified customer record to an advertiser/customer record purchaser of a user who has met a specified set of parameters. The information to be delivered with each customer record may include, among other things, an email address where the user as consented to receive marketing emails from the advertiser or a telephone number where the customer has consented to receive telemarketing calls from a specified advertiser. Typically the advertiser uses the customer record to contact the user in any one of a number of ways.

Customer records from survey (120) and customer records from ad/post fulfillment (205) are stored in the customer record data store (301). These customer records are filtered by the quality module (117). In should be noted that a customer record from ad/post fulfillment (205) will not have been previously filtered by the quality module (117) while a customer record from survey (120), which will have already been filtered by the quality module, will be re-filtered again by the quality module (117). The output from the quality module (117) is a valid customer record (302) which is passed into the offer filter module (303).

The offer filter module (303) performs a similar function as the offer matching module (119), but includes additional filters based on the demographic data (107) and the meta data (104), and survey answers (111). Customer records that pass the offer filter module (303) are customer records ready to sell (304), and are submitted to the delivery module (305). The customer records ready to sell (304) are delivered by the delivery module (305) to the client server (306) in real-time or in a periodic batch file transfer. The client server (306) accepts or rejects the customer records ready to sell (304) by sending a real time response (311). A customer record ready to sell (304) that is accepted becomes an accepted customer record (307) and a customer record ready to sell (304) that is not accepted becomes a rejected customer record (308). The delivery module (305) updates the customer record data store (301) as to whether a customer record ready to sell (304) has become an accepted customer record (307) or a rejected customer record (308).

Clients are encouraged to provide customer record quality reports (309) on the performance of accepted customer records (307) such as the percentage of accepted customer records (307) that result in a sale or some other positive customer action. This information is fed into the customer record score feedback module (310) which feeds the customer record quality report (309) data to the question selector (109) and the traffic source/flow selector (102). This data is used to refine the survey pages (110) displayed to users to improve performance. It will also be used by the traffic source/flow selector (102) to direct traffic to particular products (rewards, sweepstakes, job listings, samples, etc.) that perform better with particular offers.

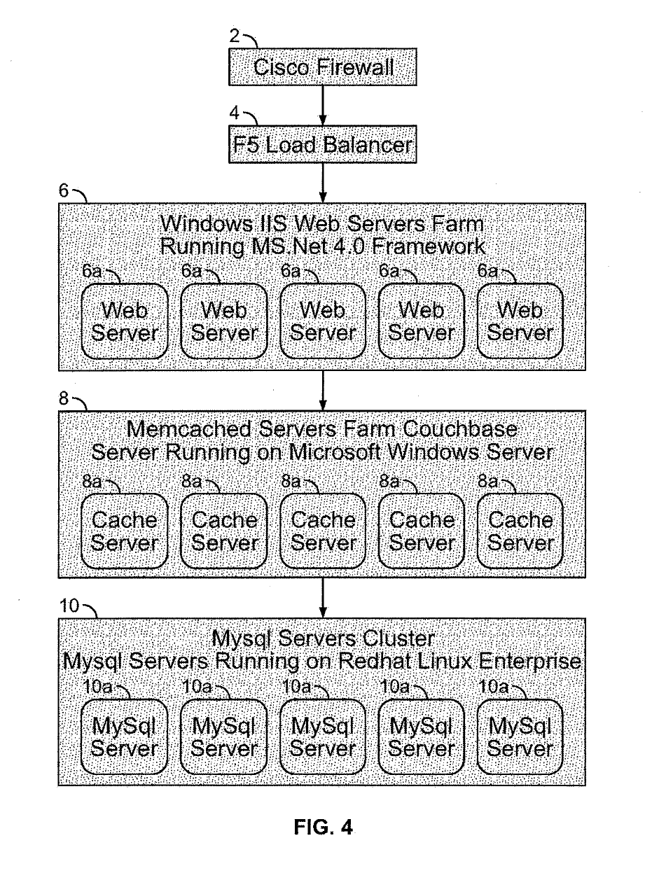

FIG. 4 depicts the hardware and processes employed in an exemplary embodiment of the present invention. Connection to the present invention is via the Internet and is device agnostic. Connection can be made with a hard-wired Internet connected PC, wirelessly connected PC such as a PC connected to the Internet via a WiFi network, or a mobile device or tablet device connected to the Internet via a cellular data connection or a WiFi connection. A present embodiment of the invention uses a firewall (2) to protect the system integrity and the data stored by the system.

Because of the large volume of users accessing the present invention, an embodiment of the present invention uses a load balancer (4) to apportion the users to one (6a) of several web servers (6) using a Windows IIS web server farm that host the websites. In an exemplary embodiment of the present invention, the web servers run Windows Net 4.0 Framework operating system though other hardware, software, or a combination thereof, could be used.

The web servers are connected to a bank (8) of memory cached servers (8a). In a present embodiment, Couchbase servers are used running Microsoft Windows server operating system though other hardware, software, or a combination thereof, could be used. The memory cached servers have the current system settings and are frequently updated/refreshed, e.g., every five minutes. These system settings determine which images will be served, the survey questions to be displayed, the offers and advertiser clients that are live, etc.

All user profile data including registration data, meta data and declared data is stored on several active SQL servers (10a) of a bank of servers (10). (SQL is special-purpose programming language designed for managing data held in a relational database management system.) A present embodiment uses MySql Servers cluster running on Redhat Linux enterprise operating system, though other hardware, software, or a combination thereof, may be implemented. Only a limited subset of user profile store is stored in active servers due to the huge amount of data. A present embodiment of the invention therefore entails periodic archiving of user profile data to archive servers thereby enhancing the performance of the active SQL servers

Accordingly, the present invention or various part(s) or function(s) thereof may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A system for determining which ads on an ad serving computer are to be served to a user, said system comprising:
a survey pages database configured to store a curated series of survey questions;
a question selector configured to prompt the user to provide answers to the curated series of survey questions;
a survey data store configured to receive the answers; and
an ad selector configured to select which ads stored on the ad serving computer are to be served to the user using the answers along with meta data and demographic data including user-declared registration information.

2. The system of claim 1, further comprising a traffic source/flow selector configured to direct a user to a registration page by traffic sources including at least one of e-mail, banner ads, and search terms, and by products including at least one of promotional offers, sweepstakes, free samples, and job listings.

3. The system of claim 2, wherein the ad server is configured to store a plurality of available advertisements.

4. The system of claim 1,
wherein the meta data includes at least one of user IP address, browser type or version, operating system or version, geographic location of an IP address using a third party service, screen size, traffic source, product, user agent, date/time stamp when the user first visited the site, and for a mobile device model, ID, type, mobile carrier using a third party service, and
wherein the demographic data includes at least one of self-reported user information, user name, address, gender, email address, telephone number, and date of birth.

5. A non-transitory computer-readable medium storing a program which, when executed by at least one processor, performs a method for determining a user profile for serving targeted advertisements, said method comprising:
prompting a user to provide declared data in the form of answers to a curated series of survey questions;
receiving the declared data;
creating a user profile using the declared data along with demographic data and meta data, wherein the user profile indicates a potential of the user to purchase the particular product or service; and
creating based on the user profile a list of ads stored on the ad serving computer to be served to the user.

6. The method of claim 5, further comprising the step of sending the determined ads to a customer record purchaser or advertiser.

7. The method of claim 5, further comprising serving the determined ads to the user.

8. The method of claim 5,
wherein the meta data includes at least one of user IP address, browser type or version, operating system or version, geographic location of an IP address using a third party service, screen size, traffic source, product, user agent, date/time stamp when the user first visited the site, and for a mobile device model, ID, type, and
wherein the demographic data includes at least one of self-reported user information, user name, address, gender, email address, telephone number, mobile carrier, and date of birth.

9. A method implemented on an ad serving computer having a processor and a memory coupled to said processor for determining customer records for serving targeted advertisements, said method comprising:
prompting a plurality of users to provide declared data in the form of answers to a curated series of survey questions;
receiving the declared data;
creating user profiles of each user using the declared data along with demographic data and meta data, wherein each user profile indicates a potential of the user to purchase a particular product or service;
creating from the user profiles customer records comprising a subset of users, among the plurality of users, who have the potential to purchase the particular product or service.

10. The method of claim 9, further comprising:
creating a list of ads stored on the ad serving computer which relate to the particular product or service and therefore are suited to be served to the subset of users that has been identified.

11. The method of claim 9, further comprising submitting the customer records to advertisers.

12. The method of claim 9, further comprising:
refining the traffic sources, promotional products and/or curated series of survey questions using feedback from the advertisers relating to actual performance of the customer records submitted and using the demographic data, the meta data and the declared data to analyze commonalities among users who purchased the particular product or service.

13. The method of claim 12, wherein the refining includes revising and re-ordering the curated series of survey questions.

14. The method of claim 12, wherein the identifying includes using A/B testing and using database searching to identify users having similar profiles to the users who had positive performance.

15. The method of claim 9, further comprising inserting user profiles via cookies on a user's browser that can be accessed by the ad server to target relevant ads when a user is online.

16. A method implemented on an ad serving computer having a processor and a memory coupled to said processor for determining which ad on the ad serving computer are to be served to a user, said method comprising:
storing a curated series of survey pages in a database;
extracting meta data and storing the meta data in a visitor data store;
providing a registration page to a user;
determining if the user is a returning user, and if so accessing demographic data from a registration data store and then using the demographic data to populate the registration page, and if not then prompting the user for demographic data;
selecting by an ads selector which survey pages to display to the user and in which order using the meta data, the demographic data, and user registration data, as well as the determination of whether the user is a returning user and any previous survey pages, and based also on a particular product or service available;
displaying the selected survey pages to the user;
prompting the user to provide answers to the displayed survey pages;
receiving the answers and storing any additional user demographic data and user registration data from the answers in the registration data store, and determining from the answers whether to serve one or more follow up questions;
combining the registration data, the meta data, and the demographic data with the answers to create or update a user profile;
feeding the user profile into a retargeting pixel module which creates one or more cookies and inserting the one or more cookies into a browser being used by the user so that the user profile can be accessed by the ad serving computer to target relevant ads when the user is online and is identified by the ad serving computer;
feeding the user profile into the ads selector to determine which ads stored on the ad serving computer are to be served to the user, using the answers along with the meta data; and
serving the selected advertisements to the user,
said method further comprising the step of using the survey answers to refine the survey pages that are displayed to the user.

17. A method implemented on an ad serving computer having a processor and a memory coupled to said processor for determining customer records suitable for serving targeted advertisements thereto, said method comprising:
accessing a plurality of stored user profiles generated using declared data from survey questions, demographic data, and meta data;
validating the user profiles by validating the demographic data and performing a profanity check;
filtering out user profiles found to be invalid;
identifying a subset of user profiles as being customer records matching with an offer of a particular product or service by (1) filtering out user profiles that were previously submitted to said offer, (2) filtering out user profiles that have been black listed, and (3) retaining user profiles that meet certain criteria of declared data, demographic data, and meta data deemed qualifying for the offer.

18. The method of claim 17, further comprising sending the customer records to an advertister.

19. The method of claim 17, further comprising receiving from the advertiser an identification of the customer records that did not result in positive action by the user, and refining the survey questions to improve customer record generation.

20. The method of claim 17,
wherein the meta data includes at least one of user IP address, browser type or version, operating system or version, geographic location of an IP address using a third party service, screen size, traffic source, product, user agent, date/time stamp when the user first visited the site, and for a mobile device model, ID, type, mobile carrier,
wherein the demographic data includes at least one of self-reported user information, user name, address, gender, email address, telephone number, and date of birth, and
wherein the declared data includes user responses to curated survey questions.
